(19) United States
(12) Patent Application Publication
(10) Pub. No.: US 2022/0400168 A1
(43) Pub. Date: Dec. 15, 2022

(54) MOBILE ELECTRONIC DEVICE CASE WITH HEATING AND CHARGING FUNCTIONS

(71) Applicant: OBSHCHESTVO S OGRANICHENNOY OTVETSTVENNOST'YU "MAFFIN KOM", Perm (RU)

(72) Inventor: Aleksandr Nikolaevich Sushentsev, Perm (RU)

(73) Assignee: OBSHCHESTVO S OGRANICHENNOY OTVETSTVENNOST'YU "MAFFIN KOM", Perm (RU)

(21) Appl. No.: 17/636,153

(22) PCT Filed: Aug. 18, 2020
(86) PCT No.: PCT/RU2020/050192

§ 371 Date: Feb. 17, 2022

(30) Foreign Application Priority Data
Aug. 19, 2019 (RU) 2019126066
Jan. 13, 2020 (RU) 2020100594

(51) Int. Cl. H04M 1/02; H04B 1/3888

(52) U.S. Cl. CPC H04M 1/026; H04B 1/3888

(57) ABSTRACT

The invention relates to the field of accessories for mobile electronic devices, in particular to multifunctional cases for mobile electronic devices: phones, tablets, etc., and can be used for heating the mobile electronic devices in the cold season. The invention provides an increase in the efficiency of heating by increasing the heating rate and the possibility of smooth control of the heating temperature. A case for a mobile electronic device, the case having a heating and charging function, the case comprising a body, a power source disposed in the body; a microcontroller disposed in the body; a heating element disposed in the body and coupled with the power source and the microcontroller, and at least one means of communication with the mobile electronic device, characterized in that the microcontroller comprises a means for generating pulse-width modulation, wherein the heating element is coupled with the power source via a bridge circuit including two pairs of semiconductor switches, and the microcontroller is coupled with the bridge circuit and the heating element via two control semiconductor switches, each of which is related with one pair of switches of the bridge circuit.

### FIELD OF THE INVENTION

The invention relates to the field of accessories for mobile electronic devices, in particular to multifunctional cases for mobile electronic devices: phones, tablets, etc., and can be used for heating the mobile electronic devices in the cold season.

### BACKGROUND

Known is a mobile phone cover with an electric heating element, which is disclosed in the document CN202496595 (IPC A45C11/24, published on 24 Oct. 2012), comprising a body, a heating element disposed in the body, made in the form of a metal wire with high electrical resistance, the heating element is surrounded by a protective layer. The protective layer is made of heat-conducting material on the side of the cover and of heat-insulating material on the side of the mobile phone. The heating element is equipped with a thermostat. The heating element is powered by a battery of the mobile phone.

The disadvantages of the known device are the inability to heat the battery of the mobile device in the cold season due to the presence of the heat-insulating layer between the heating element and the mobile device, low heating efficiency due to the use of mobile phone battery energy, and the inability to control heating and other functions of the cover.

Known is a mobile phone cover with a heating function, which is disclosed in the document CN103704966 (IPC A45C13/00, published on 9 Apr. 2014), comprising a body, a heating element installed in the body in the form of a metal wire having high resistance and sufficiently large cross-section, surrounded by a two-layer material, the upper layer of which is made of a heat-conducting material, and the lower one is made of a heat-insulating material. The heating element is connected via a two-terminal cable with the mobile phone provided with software to control the heating mode.

The disadvantage of the known device is the low heating efficiency due to the lack of its own power source in the cover, as well as due to the scheme, with which the heating element is connected to the power source, in which heating is not fast enough. There is no possibility of heating control.

Known is a mobile phone case disclosed in the document KR20140098297 (IPC A45C11/00, published on 8 Aug. 2014), selected as the closest prior art. The known case comprises a main body and a cover, a power source in the form of a battery installed inside the body, a heating element in the form of a plate disposed in the cover of the case in between the insulating layers of polyurethane, a heating mode switch, a terminal for communication with the mobile phone, a display with light indication, a heating and charging control board.

The disadvantage of the closest prior art is the insufficient heating efficiency due to the heating element control circuit that does not allow to implement fast heating of the heating element and smooth control of the heating temperature.

### DISCLOSURE OF THE INVENTION

To overcome at least some of the problems in the prior art, a case for a mobile electronic device with a heating and charging function is proposed, the case comprising:

a body,

a power source disposed in the body;

a microcontroller disposed in the body;

a heating element disposed in the body and coupled with the power source and the microcontroller, and

at least one means of communication with the mobile electronic device, characterized in that the microcontroller comprises a means for generating pulse-width modulation, wherein

the heating element is coupled with the power source via a bridge circuit including two pairs of semiconductor switches, and

the microcontroller is coupled with the bridge circuit and the heating element via two control semiconductor switches, each of which is related with one pair of switches of the bridge circuit.

In one of the embodiments proposed is the case comprising a current sensor disposed in the body and included in the bridge circuit.

In one of the embodiments proposed is the case comprising at least one temperature sensor installed in the body.

In one of the embodiments proposed is the case, in which at least one current sensor is disposed near the heating element.

In one of the embodiments proposed is the case, in which at least one current sensor is disposed near the at least one means of communication with the mobile electronic device, which is a USB connector.

The technical result of the invention consists in an increase in the efficiency of heating by increasing the heating rate and the possibility of smooth control of the heating temperature.

In the following description, the embodiments of the present invention are shown and described in more detail. It should be understood that the invention allows other embodiments, and some of their details allow modification in various obvious aspects without departing from the invention, as set forth and described in the following claims. Accordingly, the drawings and the description are, by nature, to be considered illustrative and not limiting.

### BRIEF DESCRIPTION OF DRAWINGS

FIG. 1 shows a case for a mobile electronic device in an exploded view.

FIG. 2 is a general view from the front of a body of a case for a mobile electronic device.

FIG. 3 shows a bridge circuit for controlling a heating element of a case for a mobile electronic device when current flows from a right arm of the bridge circuit to a left arm.

FIG. 4 shows a bridge circuit for controlling a heating element of a case for a mobile electronic device when current flows from a left arm of the bridge circuit to a right arm.

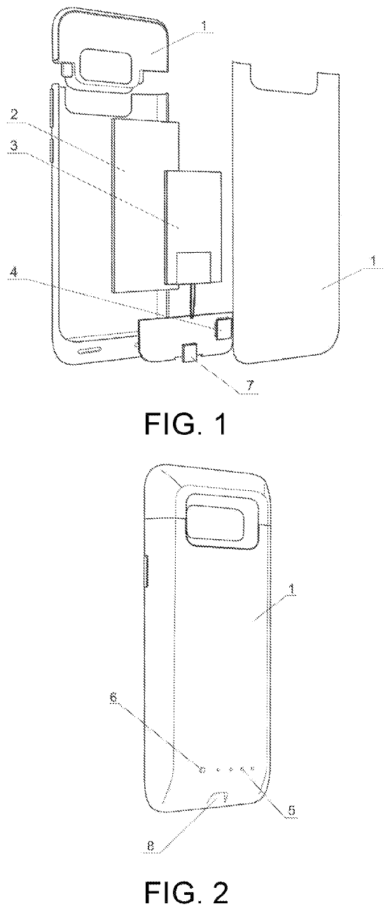

The figures are drawn to approximate scale, some elements may be shown larger for clarity, some elements may be shown smaller for simplification. It should be understood that the embodiments illustrated in the figures are not intended to limit the scope of the appended claims of the utility model.

### DESCRIPTION OF PREFERRED EMBODIMENTS OF THE INVENTION

Embodiments are not limited to the embodiments described herein, and other embodiments of the invention will become apparent to those skilled in the art based on the information set forth in the description and prior art knowledge, without going beyond the essence and scope of this invention.

Elements mentioned in the singular do not exclude the possibility that there may be a plurality of the elements, unless otherwise specified.

The invention relates to the field of accessories for mobile electronic devices, in particular to multifunctional cases for mobile electronic devices: phones, tablets, etc., and can be used for heating the mobile electronic devices in the cold season.

In a preferred embodiment proposed is a case for a mobile electronic device, the case having a heating and charging function, the case comprises a body 1, a power source 2 disposed in the body; a microcontroller 4 disposed in the body; a heating element 3 disposed in the body and coupled with the power source 2 and the microcontroller 4, and at least one means of communication with the mobile electronic device, characterized in that the microcontroller 4 comprises a means for generating pulse-width modulation, wherein the heating element 3 is coupled with the power source 2 via a bridge circuit including two pairs of semiconductor switches K2, K3, K5, K6, and the microcontroller 4 is coupled with the bridge circuit and the heating element 3 via two control semiconductor switches K1 and K4, each of which is related with one pair of switches of the bridge circuit.

Owing to the proposed configuration of the case achieved is the technical result consisting in an increase in the efficiency of heating by increasing the heating rate and the possibility of smooth control of the heating temperature.

The technical result, as will be described here and below in more detail, is achieved through the use of a bridge circuit for connecting a heating element, including semiconductor switches that switch according to a set algorithm under the control of a microcontroller with a pulse-width modulation (PWM) generator. The possibility of such control is provided by coupling the microcontroller with the bridge circuit by means of control switches. The algorithm for switching the switches of the bridge circuit is set by the microcontroller in accordance with a program, depending on a type of the heating element.

Pulsed energy supply in the form of pulses of different polarity in combination with a set algorithm for switching the switches implements a double current run through the heating element and generates a voltage on the heating element with a double amplitude relative to the power supply of the bridge circuit. This speeds up heating of the heating element. With a constant current value, the heating power increases by 70-90%.

The bridge circuit-based connection of the heating element under PWM control allows to change the frequency of switching the switches from units of Hz to hundreds of kHz. Switching the switches under the control of the microcontroller with PWM makes it possible not only to quickly change the frequency, but also the duty cycle (width) of the supplied pulses, as well as the duration of the “dead time”, which refers to the delay between switching on the upper and lower switches in one arm of the bridge circuit.

Changing the width of the energy supply pulse allows for smooth adjustment of heating depending on the ambient temperature. Adjustment of the duration of the “dead time” allows to prevent the flow of through currents. Prevention of through currents ensures not only heating efficiency, but also heating reliability. Using the bridge circuit allows to generate a unipolar or bipolar frequency signal, or to supply direct current. This possibility allows the use of various types of heaters: metal wire with high electrical resistance, metal plate, film materials, etc.

The bridge circuit, as explained in more detail below, may include a current sensor coupled with an analog-to-digital converter (ADC) of the microcontroller, with which the microcontroller under the control of the ADC implements protection of the heating element by turning off the operation of the bridge circuit when a set current value is exceeded. All this increases the heating efficiency of the heating element.

The body 1 of the case can be made of both soft and hard material: leather, plastic, etc. To implement and control the heating function, as well as other functions, in particular charging a mobile electronic device, installed in the body 1 is a board of the microcontroller 4, for example, of the Cortex-M3 architecture. As the means for generating PWM, the microcontroller 4 is provided with a multifunctional timer having a function of pulse-width modulation, such as STM32F103, which is built into the microcontroller 4, or with other known means.

The microcontroller 4 is also provided with a multichannel 12-bit analog-to-digital converter, various serial interfaces UART, I2C, SPI for connecting modules for contactless data transmission (Bluetooth), contactless data exchange with radio tags (NFC), wireless power transmission (WPC), etc.

The body 1 of the case is provided with means of communication with a mobile electronic device, for example, a USB connector 7 for connecting the mobile electronic device, as well as a micro-USB connector 8 for connecting a charging unit. Disposed in the body 1 are the heating element 3 and the power source 2, which are operatively coupled with the microcontroller 4.

In the preferred embodiment, at least one temperature sensor (not shown in the figures) is provided in the body 1 of the case. The at least one temperature sensor may be disposed near the USB connector 7 for connecting a mobile electronic device. In another embodiment, the at least one temperature sensor may be disposed near the heating element 3. In yet another embodiment, two separate sensors or a combined sensor arranged so as to be disposed both near the USB connector 7 and near the heating element 3 may be provided.

In general, the heating element 3 is a plate or wire made of metal with high electrical resistance, such as tungsten, enclosed in a dielectric sheath. The heating element 3 in the form of a film or an inductive heating element can be used as well. A rechargeable battery, preferably the lithium one, may be used as the power source 2.

The heating element 3 is coupled with the power source 2 via the bridge circuit including two pairs of semiconductor switches. The microcontroller 4 is coupled with the heating element via the bridge circuit by two control semiconductor switches, each of which is related with one pair of semiconductor switches of the bridge circuit. Both bipolar and field-effect transistors may be used as the semiconductor switches.

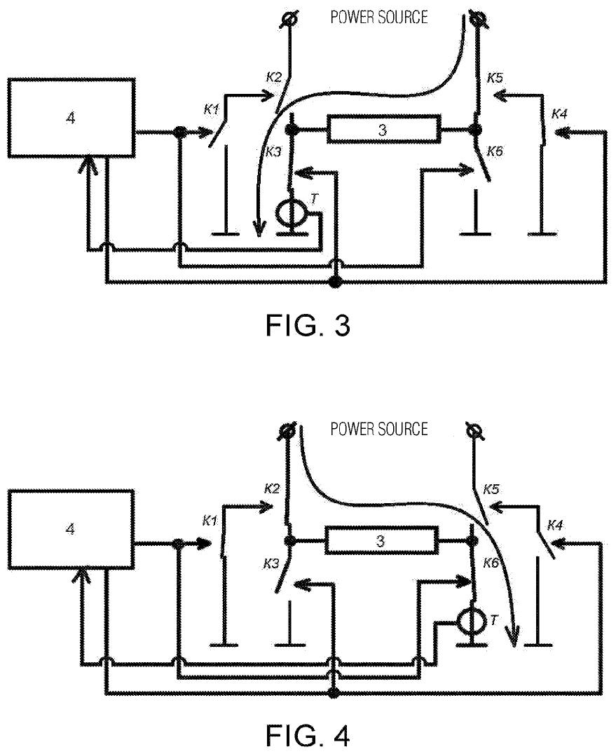

FIGS. 3 and 4 show a bridge circuit implemented on semiconductor switches K2, K3, K5, K6. Two switches K1 and K4 are the control ones. The bridge circuit and the microcontroller 4 are powered from the power source 2. The control switches K1 and K4 are used to match supply voltages of the microcontroller 4 and the bridge circuit and generate control signals for the upper switches K2 and K5 of the bridge circuit. The operation of the bridge circuit is carried out under the control of the PWM microcontroller 4 based on a set algorithm. The algorithm is set by the program depending on a type of the heating element and defines frequency and duty cycle of switching the switches, as well as duration of the “dead time”.

As described above, two types of heating elements can be used in the proposed device: induction and resistive. Preferably, induction heating elements can be used to heat devices having a metal magnetic body. The operation frequency of the bridge circuit in this case is set equal to a frequency from 250 to 350 kHz, and the “dead time” to be approximately 50-65 nanoseconds. Most preferably, the operation frequency of the bridge circuit is set to approximately 300 kHz and the “dead time” to be approximately 60 nanoseconds. These parameters are determined and set by a program stored in a memory of the microcontroller 4, depending on the inductance of an emitter in the heating element 3 and the maximum possible switching speed of transistors in the bridge circuit to ensure the highest heating efficiency by increasing the heating rate and enable smooth control of the heating temperature.

As another non-limiting embodiment, film or wire resistance heating elements may be used. Accordingly, depending on the inductance of the heating element (especially important for a wire heating element), the operation frequency of the bridge circuit is selected from 5 to 50 Hz, and the “dead time” is set from about 1 to about 5 microseconds. These parameters are determined and set by a program stored in the memory of the microcontroller 4, depending on the inductance of the emitter in the heating element 3 and the maximum possible switching speed of transistors in the bridge circuit to ensure the highest heating efficiency by increasing the heating rate and enable smooth control of the heating temperature.

In the preferred embodiment of the invention, the selected parameters are not changed under any operating modes of the device and ambient temperature, because the device circuit includes a unit for maintaining a constant level of supply voltage to the heating element regardless of the battery charge level, and the temperature is adjusted by resuming or stopping the operation of the bridge circuit. In other embodiments of the invention, the heating power can be adjusted depending on the ambient temperature and/or the battery charge level. The duty cycle of the signal supplied by the bridge circuit to the heating element, taking into account the “dead time”, is approximately 48% and is essentially a constant parameter.

Next, with reference to FIGS. 3 and 4 the operation of the proposed device is described. First, in accordance with the algorithm set by the microcontroller 4, the lower switch K3 of the left arm of the bridge circuit and the upper switch K5 of the right arm of the bridge circuit are turned on concurrently. At this time, the current flows through the heating element 3 in the direction from the right arm of the bridge circuit to the left arm, as shown in FIG. 3. Then all the switches are turned off. Then, in accordance with the algorithm set by the microcontroller 4, the upper switch K2 of the left arm of the bridge circuit and the lower switch K6 of the right arm of the bridge circuit are turned on. The current, at this time, flows through the heating element 3 in the direction from the left arm to the right arm, as shown in FIG. 4. Then all the switches are turned off again.

Under the action of the flowing current, the heating element 3 heats up. The flow of current through the heating element 3 in two directions speeds up its heating. The bridge circuit may include a current sensor T coupled with one of the channels of the ADC of the microcontroller 4 to protect the heating element 3 from overheating. The microcontroller 4 using the ADC converts readings of the current sensor into a digital value. The program executed in the microcontroller, in case when a set current value is exceeded, gives a command to turn off the operation of the bridge circuit and, accordingly, stop the heating.

The selection and smooth control of the heating mode is carried out through the interface of the mobile electronic device provided with the dedicated software using contactless data exchange means, e.g., Bluetooth. To monitor the heating and the charge level an indication means 5 is installed on the body 1 of the case, which in the preferred embodiment comprises a plurality of LEDs. Various combinations of illuminated and non-illuminated LEDs indicate the heating or charging status of the mobile device being in the case.

If it is not possible to use the mobile electronic device to control heating and charging, the case is equipped with a control tact button 6 that allows to turn on and off the heating and charging of the mobile electronic device. The presence of temperature sensors coupled with the ADC of the microcontroller 4 allows to automatically measure at a given frequency and maintain a required surface temperature of the mobile electronic device.

In the cold season, the mobile electronic device, such as a smartphone or tablet, is placed in the case having the heating function in such a way that the heating element 3 is opposite the battery of the device.

Through the interface of the smartphone or tablet, the optimum temperature is set depending on the ambient temperature. Preferably, the temperature range is set by the user from three preset settings. In another possible embodiment of the invention, the temperature range is set by the user in the range from 0 to 50 degrees Celsius. It should be understood that the maximum heating temperature of the wire heater does not exceed 70 degrees Celsius.

A corresponding combination of light up LEDs on the surface of the case will indicate that the case is in the heating mode to the temperature set via the smartphone or tablet interface. If the mobile electronic device is out of power and it is not possible to set the heating mode through it, then the heating is controlled using the tact button 6 that allows to turn on, turn off, switch heating modes depending on the duration of holding the button.

The proposed case is a small device that may be inserted and fixed in a silicone case of a smartphone or tablet. Accordingly, the device is placed near the back cover of the smartphone or tablet and does not occlude the screen and/or controls of the smartphone or tablet installed in it. Therefore, the proposed device does not create any obstacles and/or restrictions for the full use of the smartphone or tablet.

Thus, the invention makes it possible to increase the heating efficiency by increasing the heating rate and to provide the possibility of smooth control of the heating temperature.

1. A case for a mobile electronic device, the case having a heating and charging function, the case comprising:
a body,
a power source disposed in the body;
a microcontroller disposed in the body;
a heating element disposed in the body and coupled with the power source and the microcontroller, and
at least one means of communication with the mobile electronic device, characterized in that the microcontroller comprises a means for generating pulse-width modulation, wherein
the heating element is coupled with the power source via a bridge circuit including two pairs of semiconductor switches, and
the microcontroller is coupled with the bridge circuit and the heating element via two control semiconductor switches, each of which is related with one pair of switches of the bridge circuit.

2. The case of claim 1, comprising a current sensor disposed in the body and included in the bridge circuit.

3. The case of claim 1, comprising at least one temperature sensor installed in the body.

4. The case of claim 3, wherein at least one current sensor is disposed near the heating element.

5. The case of claim 3, wherein at least one current sensor is disposed near the at least one means of communication with the mobile electronic device, which is a USB connector.
